(19) United States
(12) Patent Application Publication
(10) Pub. No.: US 2011/0206824 A1
(43) Pub. Date: Aug. 25, 2011

(54) Natural emulsifiers

(76) Inventor: Joseph J. Vernice, Shirley, NY (US)

(21) Appl. No.: 12/660,302

(22) Filed: Feb. 25, 2010

(51) Int. Cl. A23L 1/035; A23D 7/00

(52) U.S. Cl. 426/602

(57) ABSTRACT

Blends of natural polysaccharide emulsifying agents are used to provide natural emulsion products. A polysaccharide blend comprising a pectin having an α-(1-4)-linked D-galacturonic acid chain is combined with at least one further and different natural polysaccharide to form the natural polysaccharide emulsifying agent. The natural emulsifying agent may be dispersed in oil which is thereafter emulsified in water. The natural polysaccharide emulsifying agents swell to provide a polymeric matrix capable of entrapping the oil molecules as a clathrate. A clathrate produced in this manner is stable to stress such as elevated temperatures.

### FIELD OF THE INVENTION

The present invention relates to improvements in polysaccharide emulsifying agents and emulsions made from these emulsifiers.

### BACKGROUND OF THE INVENTION

Emulsifying agents for oil in water as well as water in oil emulsions find numerous applications in a wide array of industries. The subject invention is based upon the recognition that an appropriate blend of several natural polysaccharide gums effectively will act as emulsifiers suitable for providing a variety of natural emulsion products.

Traditional emulsifiers are surfactants, i.e. surface-active agents, which have polar and non-polar regions. An emulsifying agent is effective because its polar region has an affinity for water whereas the non-polar region of the molecule has an affinity for the oil.

A mixture or dispersion of the surfactant, water, and oil will form small droplets known as micelles when subjected to high energy such as homogenization or other high speed shearing forces.

In oil in water types of emulsions (OIW), these micelles are essentially oil droplets suspended in water. The emulsifier forms a shell around the oil droplet and is aligned in such a manner that the polar end of the molecule faces the water and the non-polar end of the molecule faces the oil droplet. In other formulations, water in oil emulsions (WIO) are provided.

The use of emulsifiers or surfactants above a critical micelle concentration (CMC) reduces the energy required to form these coated droplets and reduces the tendency of these droplets to re-orient into two separate phases.

Although many different emulsifying agents have been heretofore available in the art, it will be seen that improved combinations of natural agents and natural emulsification products made therewith can now be provided in accordance with the subject disclosure. Furthermore, the subject natural emulsifier may also function effectively without the necessity of heating the formulations so long as the emulsion phases are both liquid.

### SUMMARY OF THE INVENTION

A primary advantage of the subject formulations is the recognition that an appropriate mixture and application of natural polysaccharide gums can act as an effective and successful emulsifier. Such natural polysaccharide gum emulsifying agents are suitable for both oil in water as well as water in oil emulsions.

The subject natural emulsifying agents contain a pectin-type polysaccharide and at least one other different polysaccharide. In one particular embodiment, a mixture of polysaccharides including pectin, xanthan gum, and sodium alginate are combined in the manner specified below and thereafter used as a natural emulsifier for a variety of oil and water products. In embodiments where the oil, water and any conventional additives are also considered “natural”, the entire resulting emulsion is also considered a natural product.

The emulsifying blends of polysaccharides may be dispersed in oil (mineral or vegetable, such as corn, olive, canola, etc) and then added to water. The polysaccharide emulsifying agents thereupon swell to provide a polymeric matrix capable of entrapping the oil molecules as a clathrate. A clathrate produced in this manner is stable to stress such as elevated temperatures. Microscopic evaluation indicates an emulsion having true micellular structure.

The pectin-type polysaccharide is a polysaccharides comprised of α-(1-4)-linked D-galacturonic acid chains, typically of β-D-mannuronic and a-L-guluronic acids, attached with 1-4 linkages and β-D-glucose backbone. The 1-4 linkages commonly refer to the covalent bonds along the sugar chain polymerization backbone.

The subject natural emulsifiers contain pectin and at least one other polysaccharide. Some preferred formulations combine pectin with xanthan gum and sodium alginate, however, these further polysaccharides may be substituted by others. The following are also suitable polysaccharides: cellulose, hemi-cellulose, arabinoxylan, chitin, beta-glucans, glycosaminoglycans, agar, carageenan, alginates, and galactomannan, etc.

Generally, the polysaccharides are stabilized by the addition of small amounts of multivalent cations such as calcium, magnesium, and other alkaline earth salts. The multivalent cations serve to lock the tertiary structure of the polymer network, thereby stabilizing the micellular structure of the emulsion as well.

### DETAILED DESCRIPTION OF THE PREFERRED EMBODIMENTS

The natural emulsifying agents utilized in formulations of the subject disclosure are comprised of a combination of natural polysaccharide gums such as pectin and at least another polysaccharide. Formulations of the subject natural emulsifier will preferably comprise 50-70% pectin and about 30-50% by weight of one or more additional natural polysaccharides and any optional stabilizer. More preferred formulations of the subject natural emulsifier will comprise about 50-70% pectin,10-20% by weight xanthan gum, 15-25% sodium alginate and 3-6% calcium carbonate.

Polysaccharides are polymeric carbohydrate structures, formed of repeating units (either mono- or di-saccharides) joined together by glycosidic bonds. These structures are often linear, but may contain various degrees of branching. Polysaccharides are often quite heterogeneous, containing slight modifications of the repeating unit. Depending on the structure, these macromolecules can have distinct properties from their monosaccharide building blocks. They may be amorphous or even insoluble in water. When all the monosaccharides in a polysaccharide are the same type the polysaccharide is called a homopolysaccharide, but when more than one type of monosaccharide is present they are called heteropolysaccharides. Examples include storage polysaccharides such as starch and glycogen, and structural polysaccharides such as cellulose and chitin. Polysaccharides have a general formula of Cₓ(H2O)_{y} where x is usually a large number between 200 and 2500. Considering that the repeating units in the polymer backbone are often six-carbon monosaccharides, the general formula can also be represented as (C₆H₁₀O5)n where 40≦n≦3000.

The subject natural emulsifiers all contain pectin which is the common name for the polymers of galacturonic acid. In its natural state, the polymer is partially esterified (up to 80%) with methanol. Calcium and magnesium compounds, such as peptides are added to stabilize the three dimensional structure of the matrix as well as enhance the emulsifier properties of the system.

The typical structure of pectin is a linear chain of α-(1-4)-linked D-galacturonic acid that forms the pectin-backbone, a homogalacturonan. Peptides are short polymers formed from the linking, in a defined order, of α-amino acids. The link between one amino acid residue and the next is called an amide bond or a peptide bond.

As stated, a further different polysaccharide is combined with the pectin in the subject formulation. A preferred second polysaccharide is xanthan gum which is a polysaccharide used as a food additive and rheology modifier. It is produced by fermentation of glucose or sucrose by the Xanthomonas campestris bacterium. In cosmetics, xanthan gum is used to prepare water gels, usually in conjunction with bentonite clays. It is not considered an emulsifier but it is also used in oil-in-water emulsions to help stabilize the oil droplets against coalescence. It is known to have some skin hydrating properties.

Another polysaccharide which can be used in combination with pectin in the subject formulations is an alginate such as sodium alginate. The compound sodium alginate is the sodium salt of alginic acid. Its empirical chemical formula is NaC₆H₇O₆. It is form as a gum when extracted from the cell walls of brown algae and is used by the food industry to increase viscosity and has uses as an emulsifier. In the most preferred formulations the pectin is combined with both of the xanthan and alginate components.

As mentioned earlier, the subject emulsifying agents are blends of polysaccharides which may be dispersed in oil and then added to water. The natural polysaccharide emulsifying agents thereupon swell to provide a polymeric matrix capable of entrapping the oil molecules as a clathrate.

In a preferred embodiment of the subject formulation, the polysaccharides comprise: α-(1-4)-linked D-galacturonic acid chains of β-D-mannuronic and a-L-guluronic acids attached with 1-4 linkages and β-D-glucose backbone.

In other embodiments, the following are also suitable polysaccharides: cellulose, hemi-cellulose, arabinoxylan, chitin, beta-glucans, glycosaminoglycans, agar, carageenan, alginates, and galactomannan, etc.

In still further embodiments, it is preferred to stabilize the polysaccharides by the addition of small amounts of multivalent cations such as calcium, magnesium, aluminum and other alkaline earth salts. The multivalent cations serve to lock the tertiary structure of the polymer network, thereby stabilizing the micellular structure of the emulsion as well.

In general, an emulsifying amount of the natural polysaccharide emulsifying agents will typically be about 1-10 parts by weight and preferably about 2-5 parts by weight corresponding to 100 parts by weight of an oil and water mixture. Conventional methods of emulsion preparation typically involve heating of the aqueous and non-aqueous phases, followed by mixing and homogenization during the subsequent cool down stage.

The polysaccharides employed in the subject natural polysaccharide emulsifying formulations are commercially available from a number of sources and are specified by quality and purity suitable for the intended applications. In the examples below, cosmetic or food grade materials were employed.

In the following examples, a series of natural polysaccharide emulsifying agent blends were prepared by mixing the polysaccharide gum powders at the indicated ratios, where parts given are by weight. Formulations A and E did not contain calcium carbonate.

TABLE 1
Examples A-H
Parts Given By Weight

| Material | A | B | C | D | E | F | G | H |
|---|---|---|---|---|---|---|---|---|
| Xanthan Gum | 10 | 20 | 10 | 20 | 20 | 20 | 20 | 20 |
| Pectin | 60 | 60 | 60 | 60 | 60 | 60 | 60 | 60 |
| Sodium | 20 | 20 | 20 | 20 | 20 | 20 | 20 | 20 |
| Alginate | | | | | | | | |
| Calcium | 0 | 3.5 | 4.5 | 5.5 | 0 | 3.5 | 4.5 | 5.5 |
| Carbonate | | | | | | | | |

Emulsion products were prepared by mixing 2.5 grams of each of the above emulsifying agent formulations with 30 parts by weight of canola oil and 67.5 parts by weight of water. The formulations were thereafter mixed with a high speed propeller blade to provide emulsion products. The pH was adjusted and stabilized using citric acid and sodium citrate. Other suitable buffering and pH adjustments additives include those weak acids and their respective salts which are of quality and purity applicable to cosmetic and personal care products.

Preservation of the emulsion products may be accomplished using conventional preservatives, such as paraben esters and phenoxyethanol, added in conventional amounts to prevent spoiling.

Samples Formula A and E produced emulsions which are markedly unstable as noted by separation of the oil and water phases.

Sample Formula B and F showed relatively better emulsion stability.

Sample Formula C, D, G and H provided the most stable emulsions, each surviving one-month at 45 degrees C. without destruction of the emulsion.

Emulsion products made as described above had a creamy consistency that applied well to skin. The rheology was such that it had a long playtime, without the stickiness or tackiness associated with polymer-stabilized emulsions.

The invention now being fully described, it will be apparent to one of ordinary skill in the art that many changes and modifications can be made thereto without departing from the spirit or scope of the invention as set forth herein.

1. A natural polysaccharide emulsifying agent comprising a blend of:
a. at least 50 percent by weight of a pectin-type polysaccharide having α-(1-4)-linked D-galacturonic acid chains; and
b. at least one further natural polysaccharide, said blend effective to promote emulsification of oil and water.

2. The emulsifying agent of claim 1 comprising about 50 to 70 percent by weight of the pectin-type polysaccharide and about 30 to 50 percent by weight of said at least one further natural polysaccharide.

3. The emulsifying agent of claim 2 comprising about 50 to 70 percent by weight of the pectin-type polysaccharide, about 10 to 20 percent by weight of xanthan gum and about 15 to 25 percent by weight sodium alginate.

4. The emulsifying agent of claim 1 further comprising a multivalent cation-stabilizing agent.

5. The emulsifying agent of claim 4 wherein the multivalent cation-stabilizing agent is selected from the group of calcium, magnesium, and aluminum cations.

6. A natural emulsion product comprised of 100 parts by volume of an oil and water mixture having 20 to 80 parts by volume oil and correspondingly 80 to 20 parts water, and an emulsifying amount of a natural emulsifying agent comprised of a blend of about 50 to 70 percent by weight of a pectin-type polysaccharide and about 30 to 50 percent by weight of said at least one further polysaccharide.

7. The emulsion product of claim 6 further comprising a multivalent cation-stabilizing agent.

8. The emulsion product of claim 7 wherein the multivalent cation-stabilizing agent is selected from the group of calcium, magnesium, and aluminum cations.

9. The emulsion product of claim 6 wherein the natural emulsifying blend of polysaccharides is present in an amount of about 1 to 10 parts by weight per 100 parts by weight of the oil and water mixture.

10. The emulsion product of claim 6 wherein the at least one further polysaccharide is a combination of xanthan gum and sodium alginate.

11. A method of emulsifying oil and water comprising the steps of providing an oil and water mixture having 20 to 80 parts by volume oil and correspondingly 80 to 20 parts water and combining said mixture of an emulsifying amount of a natural emulsifying agent, said emulsifying agent being a blend of about 50 to 70 percent by weight of a pectin-type polysaccharide and about 30 to 50 percent by weight of said at least one further polysaccharide.

12. The method of claim 11 wherein the at least one further polysaccharide is a combination of xanthan gum and sodium alginate.
